(19) United States
(12) Patent Application Publication
(10) Pub. No.: US 2016/0253639 A1
(43) Pub. Date: Sep. 1, 2016

(54) ELECTRONIC PAYMENT SYSTEM FOR FINANCIAL INSTITUTIONS AND COMPANIES TO RECEIVE ONLINE PAYMENTS

(71) Applicant: Paymentus Corporation, Charlotte, NC (US)

(72) Inventor: Dushyant Sharma, Charlotte, NC (US)

(21) Appl. No.: 15/137,724

(22) Filed: Apr. 25, 2016

Related U.S. Application Data
(63) Continuation of application No. 11/172,890, filed on Jul. 5, 2005.

(30) Foreign Application Priority Data
Mar. 11, 2005 (CA) 2500555
Apr. 5, 2005 (CA) 2503740

(51) Int. Cl. G06Q 20/10; G06Q 20/22; G06Q 20/14

(52) U.S. Cl. CPC G06Q 20/102; G06Q 20/14; G06Q 20/227

(57) ABSTRACT

The present invention provides an a electronic payment system for bank, financial institutions, portals and companies to receive payment from their customers for one or more payees. The electronic payment system allows payer (consumer or business) to use any funding method (bank account, credit/debit cards or any other business or personal account or method associated with one or more banks) accepted by the payee to initiate a payment and the payment transaction is routed to the appropriate payment processor based on payee's preferences. The electronic payment system also provides a instant payment delivery notification to the payer directly from the payee. The system also creates a unique payment tracking number which can be used by all parties associated with the transaction to track a payment's status and other attributes associated with the payment. The electronic payment system also provides a rule based payment management system for the payees to use for managing the processing and posting of the payments. The system also allows for payees to manage their payments received and post to various receivable systems based on rules defined. Additionally, the system allows payees to create rules for other aspects of payment processing. The system also allows for much simplified electronic bill delivery system which uses biller's existing infrastructure to create bill data for distribution to 3^{rd} party consolidators.

### PRIORITY CLAIM

The present application claims priority from Canadian Patent Application Number 2,500,555, filed Mar. 11, 2005, and Canadian Patent Application Number 2,503,740, filed Apr. 5, 2005, the contents of both of which are incorporated herein by reference.

### FIELD OF INVENTION

This invention is related to the field of electronic payments, account to account transfer and electronic bill payment and presentment.

### BACKGROUND OF INVENTION

A decade or two ago, financial institutions saw the opportunity whereby they can offer their customers an ability to make bill payments to multiple billers or payees. As part of understanding the implementation of this application there was a need to transfer funds from a known customer account to any payee which a user wants to make payments to. The payees could be known to the bank or not as the information about the payees was provided by the customers themselves. For adoption of this application, there was an inherent chicken and egg situation where customers would sign up for this application at the bank if they could truly make payments to more than just one or a handful of payees. On the other hand, payees would sign up if there were enough customers registered with the bill pay application provider or a financial institution. To address the deadlock, the financial institutions made a very wise choice for that time which simply meant that the customer or origin account information is well known but payee may or may not be known. So, an industry wide strategy was adopted which made payees account information irrelevant. And a PayAnyOne system was born which allowed a customer to make payments to anyone with an physical address. If the payee is known to the system, a payment will be electronically settled in the payee's account otherwise a paper check will be created and mailed to payee at payee's address as entered by the user including the typographical errors or writing style preferences (avenue vs. ave, ste vs. st vs. street etc.). This basic assumption in implementing these systems has been very successful because the user makes a payment and assumes the money has been taken out of the account instantly and transferred to the payee. These applications have been very successful in bringing a early majority of the users to sign up for the application and turn billpay into a mainstream application. However, although many enhancements have been brought to these applications over the years, but fundamentally PayAnyOne applications have simply remained the same and continue to suffer from very strong operational inefficiencies created due to the assumption of an unknown payee; and any payee entered by the user is a valid payee; and the payee identification is only done by the address information provided by the user with its own writing style preferences.

A new phenomenon which was difficult to foresee many years ago has also begun to become mainstream and that is customers can now make a payment directly to payee using payee electronic payment offering. This poses a significant challenge to the financial institutions billpay offering, so much so that financial institutions have to forego charging customers for this service. The market is now at a inflexion point where financial institutions are having to incur significant cost due to inefficient billpay payanyone application providers and can not see tangible revenues associated with the cost. Financial institutions however, still view billpay applications as a mainstream function because of the strategic benefits it offers to them.

The current system works by the customer signing up for billpay application at the provider and setting up payees and funding accounts. Because, financial institutions are uncertain about the duration of payment posting into payee's account and also want to work on a “no risk” based funding model (“good funds model”), financial institutions take money out of the customers account instantly and move it into a trust account. As fulfillment mode for significant portions of all payments are still paper check based (physically mailed), the funds are taken out of customers account many days in advance. It takes many days for electronic payments to settle and even more for the paper checks. Needless to describe, if the check is lost in the mail, it creates significant customer dissatisfaction and inquiries, building up operational cost, because the customer is wondering that the payment was made, money was deducted, and still, payee received no payment. This can sometime also cause late fees and even discontinuation of service as there is a significant confusion and communication gap created between all parties. Mostly, it is due the fact, that this model of payments where customer makes electronic payments but fulfillment is paper and/or electronic and the funds are taken out instantly but it is many days before the funds are actually available to the payees.

To address these inefficient processing challenges, banks are now implementing “risk” model where a paper fulfillment is treated like a regular check and the payment is processed as though customer mailed a check directly from his/her account to the payee.

However, billpay providers and financial institutions both are also trying other means to reduce these operational, and highly customer frustrating issues by signing up more and more electronic payees whereby they contact the payee, set them up as part of the electronic payee directory and when the payment is made to that payee, the payment fulfillment is done electronically. Although the payments are made electronically, the payee receives funds many days later than the time funds were debited from customers accounts. A customer sets up a payee and makes a payment. The bank instantly takes money out of customers account, puts the funds in a trust account and collects interest. The billpay system then tries to identify the payee and sends the settlement. It can take several days before the funds are actually received by the payees.

BillPay providers call on the payees which receive thousands of paper checks from them and try to convince them to receive electronic payments. Although, there is an incentive for the payee to stop paper check payments and receive them electronically, but it also creates an added problem and that is to receive multiple settlement files from multiple payment processors. These files are in addition to payees processing their own payments which they receive through their lockbox processors or through their Interactive Voice Response portals (IVRs), Customer Service Representatives (CSRs) or website. Billers prefer and in most cases treat this channel (through their cash management relationship and merchant care processor) as the primary (if not only) channel for processing payments. Every other channel is secondary and is on a lower priority. Consolidators many times wait for years before a payee is ready to accept the payments electronically through other channels due to cost/benefit challenges.

Additionally, since the fundamental assumption of these systems (“prior art”) is that payee is unknown, de-coupled and irrelevant, this also creates challenges to post electronic payments. Payments can be received for an account which does not exist at the payee. This problem is slightly reduced by asking the payee the account mask(s) which are acceptable to their billing systems and a edit check is conducted at the time a user sets up a payee and associated account. However, still verifying account format does not verify account ownership and creates inherent fraud and privacy issues.

These systems also have to engage into very intensive routing processes to identify how the payment will be processed and how the payment will be routed to the payee. For an example, if the payment is paper based, the heavy batch processing is engaged to collate paper checks from multiple customers to a payee to reduce cost of postage and mailing. There are cases where some of these payees are very well known names and are in many cases national payees with customers all over the country but the payment is sent to them by paper because they are not yet electronic. Secondly, even for the electronic payees, because there is a cost involved on the payee side to accept new files from new payment processors, many a times the payments are actually sent via the payment concentrators who may already have a link to the payee by knowing their account information, bank routing information and account mask information, in addition to creating a mutually agreed file processing interface. As, it is clear, to identify the payment route for fulfillment, it requires significant processing and also depends on the quality of payee directory whereby payee record as entered for payeel by one user may not exactly match the payee data entered for the same payee by another user. Some of these legacy systems are so rigid that minor changes in the payee data can result in treatment of the same payee differently. To avoid that, there are other cumbersome processes created to do sanity check of the data entered by the user. Additionally, many of these payment processors send payments to the payees via a least cost route which is more dictated by the cost of the transaction as opposed to the speed and customer expectation. In summary, these systems because they were built on a fundamental assumption of unknown payees, has caused them to grow in complexity to drive continued operational efficiencies because of the tremendous pricing pressure from the market. There is a need to simply evaluate some of these decade old fundamental assumptions and create a simplified payment system to eliminate these very complex processes.

Once again, financial institutions approach to a loosely coupled payee and a tightly coupled funding account creates many more challenges which are now becoming a competitive threat to the financial institutions and causes many restrictions as to how and when the payment is processed and what types of funding accounts are allowed for payments. For example, this approach of bill payments does not allow card funded payments. The way these systems are designed inherently limit the knowledge as to which payee can accept the credit cards and financial institutions are forced to tie the funding account to customer's banking account.

Because payees on their own sites can now allow direct payments which are both card funded and account funded, it creates a very lucrative alternative to financial institutions bill pay applications. This gives yet another reason for a new generation of system which resolves these inefficiencies.

Additional competition to these bill pay applications comes from PayPal and Certapay type of account to account transfer applications. However, these applications are more focused on Customber to Custmoer (“C2C”) or very small volume of payment transactions and the transactions which need to be instantly settled due to potentially an un-trusted merchant or receiving party.

There are also challenges as it relates to financial institutions ability to receive billing information. Customers also want to receive electronic bills at the consolidator sites. The financial institutions currently heavily depend on payee's enablement of electronic bills and ability and willingness to distribute these bills to the financial institutions and other consolidator sites. The payees have to directly or indirectly put in a lot of efforts to enable electronic bill delivery to these consolidators so much so that the number of ebills available on the financial institutions web sites is in just a few hundreds while thousands of electronic bills are available on payee direct sites. Yet again, this continues to be a mounting challenge in the marketplace to provide customer's convenience of paying bills at one place while they can also view summary of these bills at the same site of their choosing.

FIGS. 1-4 show flowcharts of prior art bill pay systems which are based on the conventional payanyone systems. As described above these systems fulfill payments either by checks or multi-hop electronic payments.

In the flowcharts, each action has been numbered to properly describe the flow of transactions.

FIG. 1 is a flow chart of a conventional bill pay based on the payanyone systems as described above. These systems became popular in the eighties and nineties and were very helpful to attract the early adopter consumers to start actively participating in the online bill payment revolution.

However, as discussed above, bill payment is no longer an up and coming application and is part of the mainstream financial supply chain product offerings. Since, it is in the “early majority” stage of consumer adoption, user requirements and expectations are so much different than the early adopters.

In the bill pay system as shown in the flowchart, a user initiates the payment transaction 101 which is received by the payment system. The user is registered with the Payment system 103 and is authenticated before using the application. Also, the billpay system 103 requires user to provide the funding account information which will act as the source of funds for processing payments. This funding account is typically a checking account of the user with the incumbent financial institution which is providing the bill pay service to the user. Since, most financial institutions have implemented a good funds model for payment processing, the funds are immediately taken out of the user account as shown in event 102. These funds are transferred to a Trust or Holding account. Because as per 102, the funds are moved instantaneously out of the user's account, it gives the user a semblance of instant receipt of funds by the payee despite many disclaimers by the financial institutions on their web and and/or wireless portals. It should be noted here that good funds or risk based models are both applicable to prior art and the present invention.

As both step 101 and 102 are very tightly coupled with the consumer's checking account, and does not take into account any merchant relationship and payment method instruments of choice of the biller/payee, banks and other financial institutions are finding it very challenging to offer diverse payment instruments for bill payment transactions other than the checking account(s) consumer has with the incumbent bank or the financial institution. FIG. 2 will discuss how biller direct web and and/or wireless portals of the payee/biller have a tremendous edge over banks in this regard.

Once the payment system 103 receives the payment transaction it performs a payee directory lookup 104 based on the physical name and address information provided by the user about the payee. A payment transaction also has a reference to the payee information which is entered by the user based on user's own style of writing. Example, Water Ste or Water Street or Water St.

Payee Directory is searched to find the payee for processing the transaction. Test 105 will verify if the payee is present or not. If the payee is not present in the payee directory, a paper check 106 is mailed to the payee. The paper check is typically drawn from the trust account (“Good Funds Model”) or from the user's account (“Risk Model”). The paper check is received by the payee through physical mail and funds are typically received in 3-5 days from the date of payment initiation by the user. In good funds model, it has even a bigger user expectation management issues as the funds are taken 3-5 days before the payment is received by the payee. This can even turn operationally chaotic as the check may be lost and can affect user's ability to get service from the payee and many cases may include late payments. Compounding the situation is the fact that many of the payees setup by the user may receive electronic payments and others through paper check and it is very hard to know which payments are processed and received when.

Once the Payee is found in the payee directory of the payment system per 105, another verification 107 is performed to find out if the payee is a Paper based payee meaning the method of payment fulfillment is by mailing a paper check; or the payee is an electronic payee meaning the payment can be settled through electronic means.

If the payee is marked as the paper payee (or a non electronic payee), the payment is sent to the payee via a paper check as in 108. Now, the next level of complications exist is in managing the cost of processing paper payments. In many cases, most of the payments received by the payment system are still processed through paper due to various inefficiencies because of the fundamental approach of payanyone implementations of 1980s and 1990s. To reduce the cost of paper processing, the payment systems may consolidate the payments of a payee into one envelope to save cost of the stamps. This is however, done by comparing the payee information particularly the physical address as typed by the users and if the match is found, it is considered a consolidated payee and the payments for the payee are consolidated in one envelope and mailed. The inherent and fundamental approach, design principles and basic assumptions have rendered these systems so inefficient that a payee record of AT&T or BellSouth may be repeated one million times by one million user as the approach of identifying payees by their physical address and that of the payee is unknown till it is known by identifying its address or a backend electronic relationship with the payee.

If the verification 107, means that the payee is electronic, the payment transaction is processed electronically. Once the payee has been established as an electronic payee, a payment route for the payee is established by the step 109. The payee is either connected directly to the payment systems or the payments are sent through concentrators.

If the payee is setup as a direct electronic, in the step 110, an ACH transaction is sent to the payee's account in the payee's financial institution. A separate remittance file is sent to the payee for processing. However, this approach has many inherent issues. Because payees as discussed above and will be further detailed as part of FIG. 2 description, payees offer biller direct payments, direct EFT transfers and have their own lock box processing arrangements in addition to merchant relationships for accepting processing credit cards (“On Us Transactions”). This 3^{rd} party payment processor arrangement, as depicted in FIG. 1, becomes yet another channel for receiving payments for the biller. That means a biller will receive funds into its account through the payment system and potentially a daily file of the transactions and biller posts these transactions to the billing system with a status of “payment received” after all the On Us Transactions have been processed. Additionally, this approach makes very hard to bring on new payees as direct electronic because a justification and value proposition needs to be created for the payee to do the integration work for receiving payments from yet another payment processor. That is why bill pay application using conventional model according to FIG. 1 record statistics of checks they send to a specific payee and later justify to the payee how it will be beneficial to receive these payments electronically as they are currently sent as checks. This means that there needs to be a sufficient check volume to be able to send payments electronically the payee. Because the development and operational efforts on the billers end can be non-trivial and in many cost of converting paper to electronic out weigh the benefits, consolidated payment providers many times wait for months and even years to get a payee to convert electronically.

Largely due to these issues, bill pay application providers will contact concentrators such as Visa International Services Association ePay, or MasterCard International Inc.'s Retail Payment System (RPS) and others to send payments to payees which are already reachable by the concentrators. These concentrators follow the similar process as outlined above to sign up payees. Most often however, the payees which are reachable through concentrators are typically financial institutions and credit card providers and not many utility, telecommunications and companies from other industries.

Because this approach to transaction processing is based on accepting transactions for any payee which may not be known to the network, and because of the difficulties the entire conventional bill pay industry faces (including the concentrators), there is no verification of the payee account holders' ownership of the account. At best, only the account mask is verified. As long the account mask is correct, payment can be received. Like discussed before, this approach served its purpose to have early adopters to use bill pay systems. Now that this is turning into a mainstream application, the requirements are different and security, privacy and fraud are very important issues.

Going back to FIG. 1, at step 109, if the payee is not direct (which more likely than not for most bill payment providers today due to the difficulties of the un-scalable model discussed above), the payment is routed through a concentrator, step 111. In this step the bill payment provider using conventional payanyone model for payments, maintains an account with the concentrator and the concentrator settles the payment with payee based on the transactions received from the application provider. Application provider and the concentrators than do settlement between themselves. Later on, the bill pay provider will settle its accounts with the financial institution who originated the payment transactions.

The funds settlement from the user's account (although debited immediately) to the payee's account generally takes from 2-3 days. Because of the uncertainty and lack of clarity in timing of the payment processing, it also results in significant operational cost resulting from calls by the user to research and trace their payment status.

As discussed above, this approach served its purpose but has outgrown its usefulness.

FIG. 2 is a flowchart of a conventional biller direct bill payment system. These applications are offered on the biller's web or and/or wireless portals for their customers to access and make payments. These applications can be part of a wider web offering by the biller such as self service, account management, and other bill presentment and payment offering.

A user either registers for the full function web site or may just want to make a payment without the need for any enrollment.

In step 201, the user makes a payment to the payee. Since, it is payee direct and part of many times, payee's web portal, the user can only pay this specific payee. In this system, the payee controls the payment routing and processing timing and approach based on its relationship with its own financial institution who is processing payments or the merchant processor for card based payment processing. The payee decides which payment methods are acceptable or not for processing the payments. For example, the payee can make a decision if he wants to offer credit cards or not. If it does, then what type, Visa, Mastercard, Amex, Diners etc. The same applies for debit card based payment instruments.

Because of this flexibility, many users are choosing to use biller direct sites to make payments as they can have variety of payment instrument which can be used to fund the payment transaction. This poses competitive challenges to the financial institutions who offer bill payments.

Once the transaction is initiated, 202 verifies if the transaction is funded through a checking account or has been funded through a credit/debit card. If the transaction is funded with a checking account, the transaction is placed for store and forward for cash management bank or lock box processors for payment processing. Please note the key factor here is that the payment is generally being routed through the same channel as the biller uses for check or direct debit payment processing. This allows biller to get the volume discount and does not require biller to make any changes to its internal system as the remittance posting processes, file formats and timing is already pre-defined. In essence, this channel is what payees consider as the mainstream channel and in many cases the only channel payees identify as their channel for payment processing. As described in FIG. 1, conventional bill pay system will need to interact with the payee at this level and get the payee to accept the payments and remittance information through an alternative channel which payees are very reluctant to do.

Once the cut off time is reached, the payment file is created. This can be in National Automated Clearing House Association (NACHA), Electronic Data Interchange (EDI) or any other Electronic Funds Transfer (EFT) format such Automated Clearing and Settlement System (ACSS) of Canada and Automated Clearing House (ACH) in USA. Once the file sent to the financial institution, in step 205, the payment is processed whereby financial institutions takes money out of customers account from their financial institutions and post into billers account.

Because the funds are not pre-debited from users account, the transactions are processed as electronic payment requests or payment drafts. It takes one day to process the transaction from payment initiation to payee receiving funds.

If the payment is card funded as verified as part of step 202, that means the payee has a pre-established merchant relationship with a payment processor for processing card funded transactions. In step 204, the payment is received by the payee and sent synchronously or asynchronously to the payment processor for processing. Once again, the payee receives funds the same day of payment initiation.

As depicted in FIG. 2, payees and the users of the payee direct model of payments have much more flexibility and control than offered in conventional payanyone systems. The user makes payment to the payee and feels that the payment is instantly received by the payee. This means that the payment can be made the same day of due date rather than many days in advance. This means no opportunity for late fees unless there is an exception. In case of Non Sufficient Funds, the user is responsible for the fees.

Secondly, for users who want to use credit cards for payments, are able to do it in this model.

FIG. 3 is a flowchart of a conventional email based payment system or a consumer to consumer payment system typically offered by companies like Paypal and Certapay (“Prior Art”). This system is typical for low volume merchants and merchants who generally do not have or cannot have a merchant relationship. Secondly, both parties are typically non-trusted entities (or unknown to each other), there is a requirement for instant settlement of payments and the service providers charge a substantial premium for processing these payments. However, if the payment is with a trusted party and/or for large volume payments, payees and consumers do not prefer this method primarily because of the customer experience and the cost of processing each transaction as the systems have been optimized for processing small volume of small transactions.

A user accesses the service provider's web portal in step 301 and intends to make a payment. The user can be a registered or an un-registered user. User sets up funding account information 302, whereby user tells the system if he/she intends to use a card or checking account. User is asked to setup the funding account information by providing routing transit # and account number for the account funded transactions and for credit card transactions the user provides card number, expiry date, address verification etc.

As explained above, these systems are targeted for instant fulfillment of payment transactions because of the nature of interaction. In 303 the funds are taken out of the customer's account and moved to a Trust account or a phantom account with the service provider.

Step 304 requires user to provide the payee information either by selecting the payee who is already registered with the provider or by providing the email information for the payee.

Step 305 is a verification step to verify if the payee exists or not. If it exists, the funds are transferred to the payee's account as shown in the step 306. If the payee does not exist an email notification 307 is sent to the payee informing the payee that the system has received a payment for the payee and the payee can setup the account information and register with the system to receive the payment.

The payee registers with the system 308 by providing the account information and the funds are transferred from the System Account (Trust account or Payer's phantom account) to the payees bank account or the Trust account with payment amount minus the fees for payment which could be significant if this method is used for high volume payees or the trusted payees who are used to paying very insignificant amounts per payment. Generally, these systems are good for small amount of small number of payments to unknown payees. However, there exists a need to process payments for SOHO (small office home office) and personal payees with similar process as with the large volume payees with much simpler payment experience and cost.

FIG. 4 shows a flowchart of a biller's process for distributing its bills to users accessing its bills at a bank or other consolidators using conventional bill payment systems. The objective is to explain the complexity it entails to enable bills for publishing on the web. Additionally, this requires a significant capital expenditure if built in-house or requires a substantial commitment for monthly payments for outsource provisioning of ebills capability. Because of the cost and complexity, only the high volume billers are able to offer the functionality. In the marketplace today, according to the conventional bill distribution in FIG. 4 there is no economical way for any biller to allow its users to see its summary bill information (Amount Due, Payment Due Date, Minimum Due . . . ) without following the process outlined. This also means from the time of making the decision to publish bills it can take several months to year(s) to implement. This has created a chicken-and-egg problem for the adoption of bills at the financial institutions web site and/or any other web billing portal.

Because of the way the conventional ebills system functions, a significant integration with the backend systems is required billers to convert their paper format of bills to web a web format such as Extended Markup Language (XML), Hyper text markup language (HTML), Portable Document Format (PDF) for later enablement to 3^{rd} party ebills distribution. The FIG. 4, describes the conventional system which enables payee to distribute bills to 3^{rd} party.

In 401, biller decides to allow 3^{rd} party ebill distribution. The billing information is generally extracted from print streams. The print streams are the printer definition language, which instruct the printer to print the document with presentation attributes. The billing information can also be made available by more sophisticated backend billing systems by extracting information from a database or a dataset which can be very complex. The reason most billers prefers print stream or the format which they use today for communicating with their print provider, is the simple fact that the billing information is most accurately available when the bills are ready for printing and have no chance of having any tariff or discount business logic related issues.

But the print streams are unstructured documents and each biller's bills/statements are unique and each bill for a particular biller can be unique. This means a highly complex process for extracting the meaningful billing information such as payment due date, amount due etc. The integration rules are setup 403 to convert the conventional billing information for web delivery. Typically, this process itself can take from 6 to 9 months.

Once the paper format of the bills has been converted to web format, the system is now ready for building interfaces for delivery of ebills to 3^{rd} party consolidators. This is typically done by extracting the summary bill information from ebills and converting them to the proprietary format of the consolidators. Unfortunately, each of the consolidator has their own proprietary interface specification of data set or a set of inter-related files for exchanging summary billing information. Only a handful of sophisticated billers with huge volume of bills will undertake to implement complex interfaces with multiple consolidators.

Because bill information is very detailed, complex and requires significant amount of data storage, consolidators only want to deal with the summary bill information (Thin aggregation) and refer the user for detailed billing information to go back to the biller's web site either synchronously through seamless login or asynchronously. Summary information is extracted from the bills in 405 by extracting it from the ebills converted from complex paper bills formats.

Because this process requires significant short term and/or long term investments from the billers, the billers do not want to distribute bills to 3^{rd} parties unless the papers bill will be truncated by the user meaning the user will receive electronic bill only and no paper bill. This helps to attain the ROI for the payee.

The file exchange protocol with the consolidator and the payees takes into account all the permutations and combinations of these business rules. In practical aspect, this conventional approach as depicted in FIG. 4 may require up to 15 months or more for implementation, a significant challenge to biller adoption.

As evident from the aforementioned background on the prior art that the payment systems and bill payment applications currently implemented have not kept up with the changing technological advancements and are fundamentally designed with very in-efficient and rigid processes and keeping the customer from enjoying true benefits of next generation of payment systems.

In general, because the current bill pay applications at financial institutions are modeled on a “don't care about payee” or “any payee is a valid payee” assumption there are many inherent challenges with prior art systems.

### SUMMARY OF THE INVENTION

It is an object of the present invention to provide a novel system and method for payment processing that obviates or mitigates at least one of the above-identified disadvantages of the prior art.

Aspects of the present invention provide a means for consumers to make payments at one consolidated place and to see the summary bill information at the consolidator's site, without necessarily stopping receipt of paper bills and/or go through complex enrollment process. There is a need for a system which de-couples billers enablement of electronic bills from a consolidator receiving a summary or remittance information for displaying to user as part of enhanced consumer experience for making payments to payees. This should be done in such a way that it allows the Payees of all sizes and volumes, whether large billers like AT&T or small Joe's Lawncare to provide access to summary information to the consumer and for consumer to see this information at a consolidator's site or any other site of his choice to make a payment.

The present invention provides a new model for payment processing which is fundamentally different than current payanyone based billpay systems and presents model for payment processing which is more efficient, cost-effective and offers increased velocity of payments.

Bill payment is now a main stream application. It has already made a transition from “early adopters” stage to “early majority” and customer needs are no longer the same as they used to be. Early adopter is customer who is trying new technologies early on and is very flexible and ready to try new things and many a times is accepting of inefficiencies in the system because of the convenience he gets out it. However, in early majority, the customer is expecting operational behaviors from the system similar to his/her existing applications.

Aspects of the invention provide benefits to the customers of bill payment applications and additionally create an environment whereby banks and financial institutions can keep up with the changing environments and once again offer a meaningful bill pay service while significantly reducing the cost structure. Additionally, payees can exercise more control over the payment processing and the timing and would receive funds much quicker than currently possible.

Aspects of the invention develop a payee directory which captures much more information about the payee and how payee wants the payment to be processed than the prior art.

Aspects of the invention maintain a stronger awareness of the payee's payment processing preferences such as type of payment methods allowed such as checking, saving, credit cards (Visa, MasterCard, Amex . . . ), debit cards etc. Additionally, aspects of the invention maintain processor preferences such as financial institution A for ACH payments and processor B for card transactions.

Aspects of the present invention treat the Bill Payment transaction as a Payment Draft or a Payment Request to pay for the services from the payee. Bank becomes a service provider where user can make payments in a highly secure and trusted environment to multiple payees of user's choice. The payment request then has the flexibility of being funded from multiple sources allowed by the payee and the bank and the system has the ability to route the payment request to payee directly for further processing of payment by the payee's merchant and payment processors. This de-coupling of payment transaction from an account transfer (per conventional model) makes the payment processing very simple and flexible. Additionally, the present invention treat the payanyone payment for the bill in no different way than any other payment transaction for any electronic commerce activity. So, the transaction becomes an entity on its own, can be routed, processed, tracked, traced and as a unit as opposed to a banking transaction activity to withdraw money out of consumer's account and send the funds to payee by check or electronic. This fundamental shift paradigm allows a payment transaction to be routed to the payee and payee's processors for processing irrespective of where the transaction was originated from: bank, portal, billers own web, voice or wireless portals. This is exactly what payee and payers want because when the payment is made by the user, the payment needs to be instantly sent to the payee for processing. And all parties involved: bank or non-bank payanyone billpay provider, payee and the consumer should be able to view the same payment transaction in the same way and track and trace it much in the same way as a shipment is tracked by the receiver, the sender and the service provider.

Aspects of the invention include a system designed as a payment network of payees and payers. The payees are setup in the system either by self enrolment or by a manual setup. Payment critical information about the payee such as payment method preferences (ACH, credit . . . ), payment processor, merchant account information, account mask, receiving account information such bank transit id, account number etc., is captured. A directory of these payees is created. Each payee is uniquely identified. A payee can be a large business, smaller business or a personal payee. On the other end of the network are billpay application providers. These can be banks, financial institutions, portals, and any other applications or enterprise providing bill payment applications to its customers including billers offering biller direct payments.

This can allow users to use different type of payment methods for bill payments. The system also stores payment attributes of the payee and displays it to the user when user is setting up the payee and also when user is about to make a payment. Once a valid payment is made, the payment transaction is sent as a “Payment Request” to the system and system then routes this request to the payment processors as selected by the payee for this particular payment type. This routing can happen synchronously (in the same communication session) or asynchronously (in a different communication session; online or batch). Because the payment is being channeled through the same mechanism as payee itself uses for its own payments (can also be different but likely same), an instant payment receipt or a PDN (payment delivery notification) can be sent to the customer which confirms that the payment was received by the payee and is being processed. The funds transfer in case of credit card can be instant. In case of ACH or account funded payments, the transfer of funds from customers account occurs much later than the prior art which deducts the funds right away from the customer's account and deposits it into a trust account for later settlement. This provides much needed relief to the customer experience and expectation management which does not force immediate funds deduction from customer's account while payee receives funds many days later, causing communication gap between these two instances and originating many research calls to call center from the customer to verify where the payment is.

This process can be followed for payees, which have large volumes of payments and have merchant relationships. The system also has a default payment processor relationship which allows it to process payments for payees who either do not have existing merchant relationships or prefer to use default payment processors for card or account funded payments.

Because the system is flexible and captures and routes payments based on all the payment attributes of the payee itself, the same system can also be used to process biller direct type of payments. This system can be used by the payee to allow links on its web site and/or the IVR or phone systems, or wireless portal or back office systems to allow customer service representatives or agents to accept payments (ACH, card funded) and process these payments using payee preferences. In essence, the system builds and provides a network which allows for payment origination from payee direct sites as well as consolidator sites such as banks, portals etc. and process these payments based on payee preferences and payee's merchant relationships. This notion makes it very flexible and efficient by eliminating the need for very complex processes as discussed earlier. Similarly, the system can also be used to process and route payments which are received through Payment Concentrators. Payment concentrators are entities which have existing relationships with financial institutions and process payments on their behalf. This system allows for faster payment processing and is built on a next generation of payment routing model (as opposed to least cost routing, it is based on payee centric routing), making it desirable for concentrators and payment processors to use this system for payment processing.

Additionally, the system also provides different dashboards for interacting with network. A Payee dashboard allows for the payee to track and trace payments through its back office agents and research payments, perform analysis on the payment data, view reports, change payment attributes and so on. The system also allows for many payment actions which payees can perform using the payment dashboard such as make or accept user payments, adjust payments, hold or cancel the payments on user request, answer questions about specific payments.

Similarly, the system also provides a FI dashboard which allows financial institutions, banks, collection agencies, portals and other bill pay application providers to access payment information. View payment reports, perform analysis on payment data. Additionally, they can perform multiple payment related actions similar to those described for payees. FI agents can accept or originate a payment on behalf of the user, make payment adjustments, hold or cancel payments, answer any questions related to the payments and so on.

A similar dashboard is provided for the payment concentrators and payment processors whereby they can access a Concentrator Dashboard and perform similar functions as described above.

The system also has customer dashboards. The dashboards for the customer are different based on if it is a customer of a payee or a customer of a consolidated bill payment application. On payee direct site, the customer can make or schedule payments to only the payee and the look and feel is that of the payee's web site and to the customer it appears that the customer is interacting with the payee web site n only. On the other hand, though similar concept but the FI customer dashboard allows user to setup multiple payees, make payments to multiple payees, schedule payments to multiple payees and so on. The look and feel is branded based on the financial institutions web site and the customer feels that he is interacting with the banking application only.

All these dashboards also have API based interfaces where these could be integrated more tightly into other applications and other such as IVR, voice portals or wireless portals of the biller, bank or non-bank bill service providers.

Aspects of the invention allow payees to receive payments from multiple sources and then send remittance information to the payee in one file. The goal is to reduce amount of efforts required to setup payees to receive payments from multiple sources.

Aspects of the invention allow payments to be made for small businesses which have very small volume of payments but would like to receive similar quality of service as larger organizations. The payees can setup much in the same way as the large payees and register their payment preferences and payment processing and merchant processing requirements.

The system also allows for payments to be made to personal payees which in the prior art currently receive payments through paper checks and unfortunately have tremendous operational cost associated with them. This system allows for personal payees to setup on the system and receive payments directly into their account using payment routing capabilities of the system. This system also allows for payments to be made to personal payees who are not yet signed up on the system. The payment can be fulfilled either by paper check (last resort) or by moving the money into a trust account and inviting the payee using its email address to setup and receive funds. The system allows for payments be account funded (preferably) or card funded.

This system also solves a chicken and egg problem for electronic bill content availability and distribution. Payees use remittance information for updating accounting systems. The remittance information typically contains payment amount due, due date, minimum due, account number etc. This information is contained in the liability file on a per account basis. This is the similar information needed by the summary ebills for delivery to 3^{rd} party consolidators. Aspects of the invention include a system and method which allows the use of liability file as a source for providing summary bill information for authentication and distribution of electronic bills to the consolidators as opposed to web format of electronic bills which is very cumbersome. This approach is simple and substantially reduces and/or even eliminates the need for complex efforts required to enable electronic bills by the payee.

### BRIEF DESCRIPTION OF THE DRAWINGS

Embodiments of the present invention will now be described, by way of example only, with reference to the attached Figures in which:

FIG. 1 is a flowchart of a conventional billpay system based on Payanyone model of payments “Payee don't care” model (“Prior Art”);

FIG. 2 is a flowchart of a conventional biller direct bill payment system allowing billers/payees to receive payments on their web or voice portals (“Prior Art”);

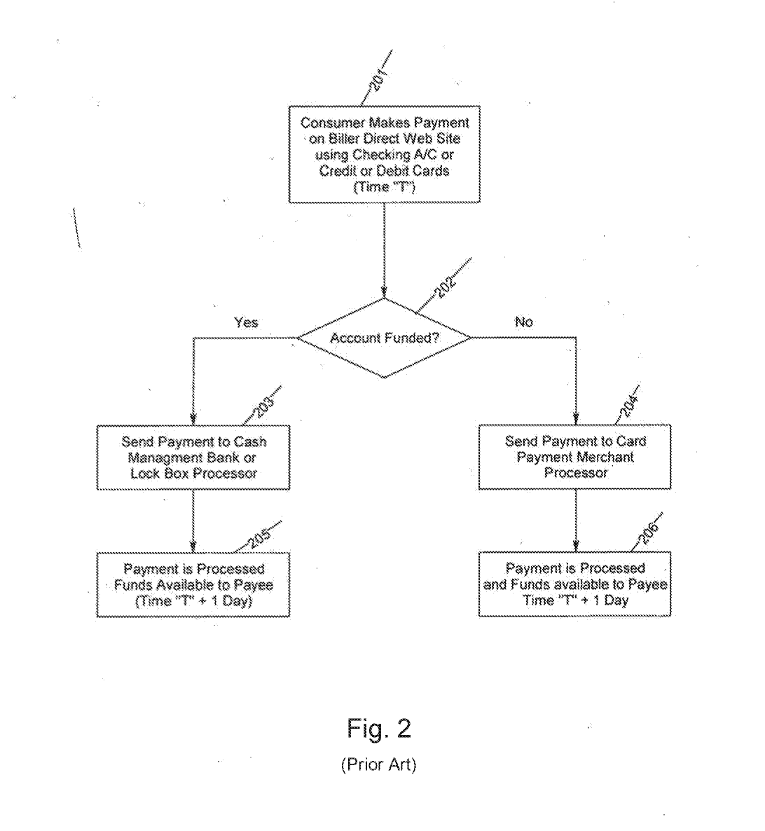

FIG. 3 is a flowchart of a conventional consumer to consumer payment system or email based payment systems e.g. certapay, paypal (“Prior Art”);

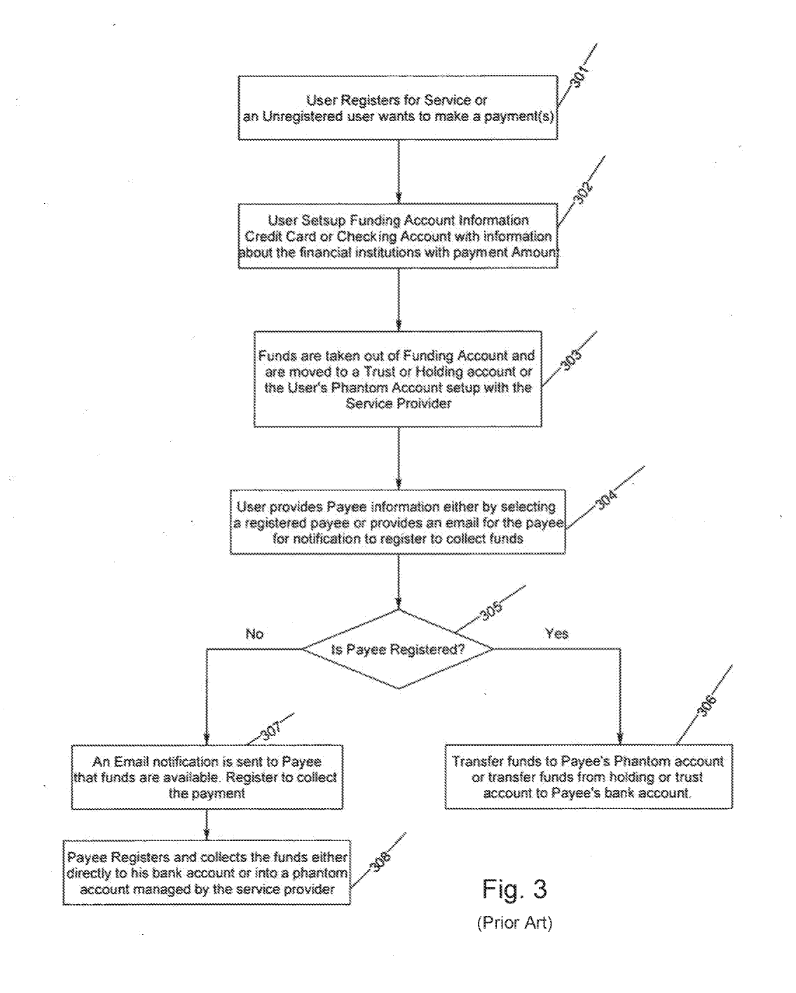

FIG. 4 is a flowchart of a conventional 3^{rd} party ebill distribution model to allow biller to distribute bill summary to consolidators (“Prior Art”);

FIG. 5 is a block diagram of an embodiment of a bill pay system according to the present invention;

FIG. 6 is a flowchart of a payment transaction processing flow according to the present invention, for the transactions which have been funded using a checking/saving account;

FIG. 7 is a flowchart of the card funded payment transaction processing flow according to the present invention;

FIG. 8 is a flowchart of the registration process for a payee to enroll for a rule based consolidated payment management system (RBCPMS) with a billpay application provider who is offering a billpay system according to present invention;

FIG. 9 is a flowchart of a process for setting up a new payment processor or payment gateway to enable the payment network to process payments according to the present invention;

FIG. 10 is a flowchart of a payee by the user of the bill pay application according to the present invention;

FIG. 11 is a flowchart of the user interaction with the Payee Direct personality of the present invention typically offered on the payee's web and/or and/or wireless portal;

FIG. 12 is a flowchart of the user interaction with the consolidated bill payment personality of the present invention typically offered on the banks, portals or other financial institution's web and/or and/or wireless portals; and

FIG. 13 is a flowchart of the 3^{rd} party ebill distribution by payee to the bill consolidators according to the present invention.

### DETAILED DESCRIPTION

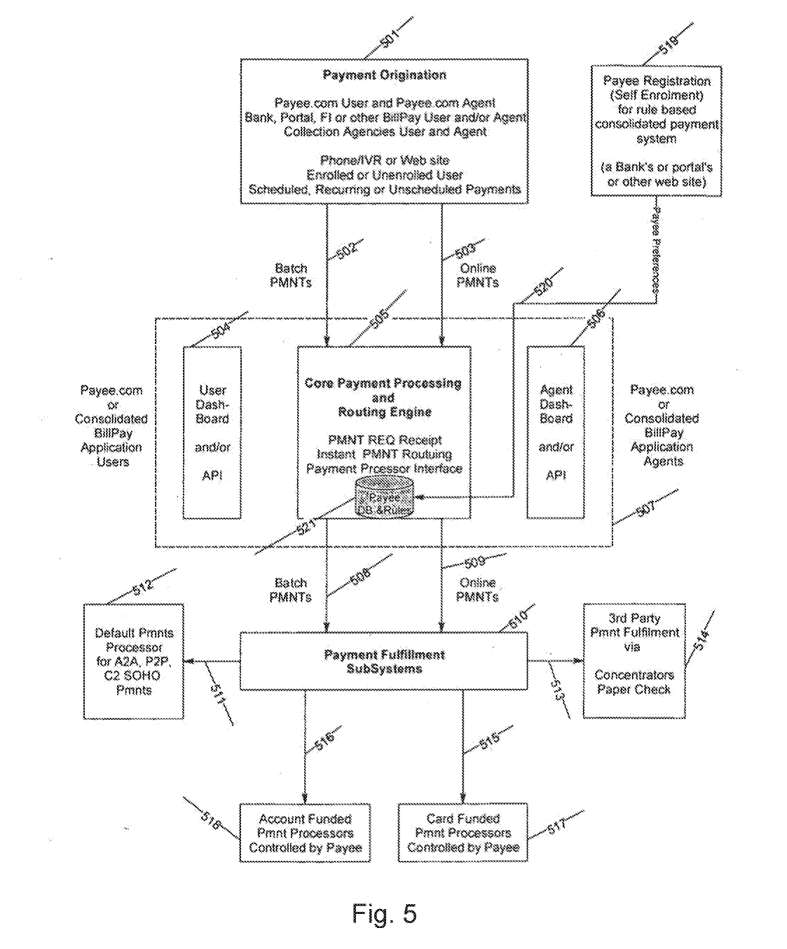

FIG. 5 is shows a bill payment system according to an embodiment of the present invention.

The payment transaction can be originated from multiple sources 501:
User of biller direct payment system at biller's web and/or and/or wireless portal;
Customer service or other agent of biller direct payment system at biller's web and/or and/or wireless portal;
User of Bank's or a non-bank Payanyone bill payment system at web and/or and/or wireless portal;
Customer service or other agent of a bank's or non-bank's Payanyone bill payment system through web and/or and/or wireless portal;
Collection agencies' users or agents; or
Any other application or system needing to make a payment to a payee of any type.

This also allows a payment transaction from an enrolled user or an un-enrolled user. The payment processing can be setup to happen synchronously with transaction initiation or asynchronously.

The transactions can be initiated in batch or online formats. The payments can be scheduled payments, recurring payments or unscheduled payments.

The payment origination can also occur from variety of systems:
The payment can be initiated by directly accessing the payment system according to the present invention by a and/or wireless and/or voice portal;
The payment can be initiated by connecting to the bank's or non-bank's voice or web payment portal;
The payee direct or a payanyone payment can be initiated by using Application Programmatic interface of provided by the system;
The payee direct or a payanyone payment can be initiated by seamless sign-on to the system;
The payee direct or a payanyone payment can be initiated by file interface of the bill pay system; and
Other methods including but not limited to wireless payments.

The payments batch (502) and online (503) are received by the bill payment system's core payment processing and routing engine 505. The bill pay system also allows for comprehensive functionality related to the payment transactions tracking and management and administration of the system.

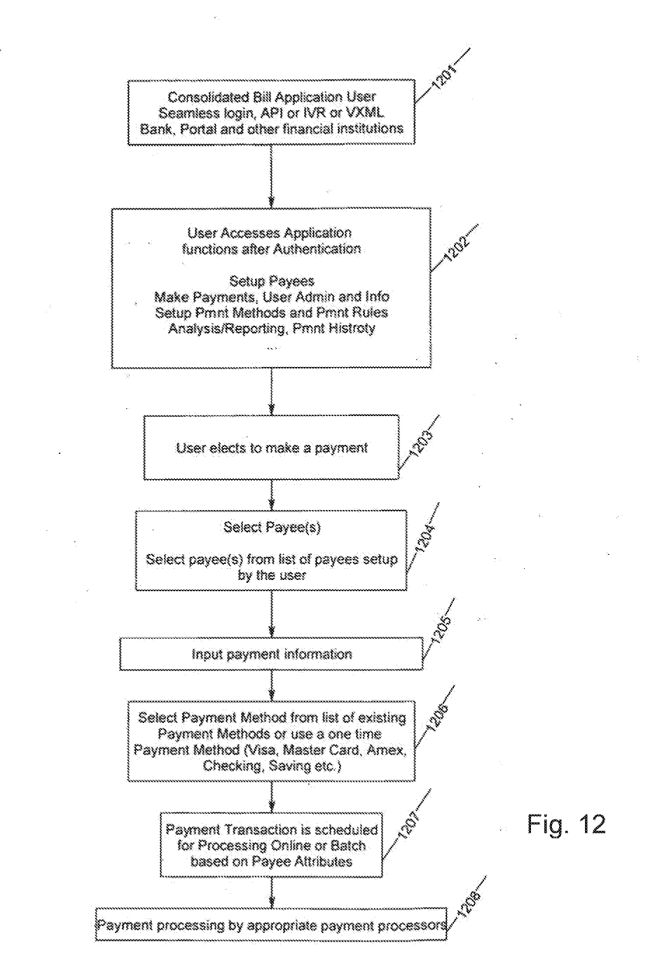

The user's of payee direct (payee's web, wireless or voice portal) and/or portals (banks or non-banks payanyone payments web, wireless or voice portals) can access the system through User Dashboard and/or through APIs of the same accessed as part of the other system. The dashboard allows users to perform multiple functions including detailed tracking and tracing of payments (user interaction discussed in detail in FIG. 12). User's can schedule payments, setup payees (in case of portal payments), setup payment instruments etc.

Similarly, the bill payment system also allows, agents of the payee direct system or the portal payment system, to access the bill payment system according to the present invention, through an Agent Dashboard and/or APIs (506) thereof.

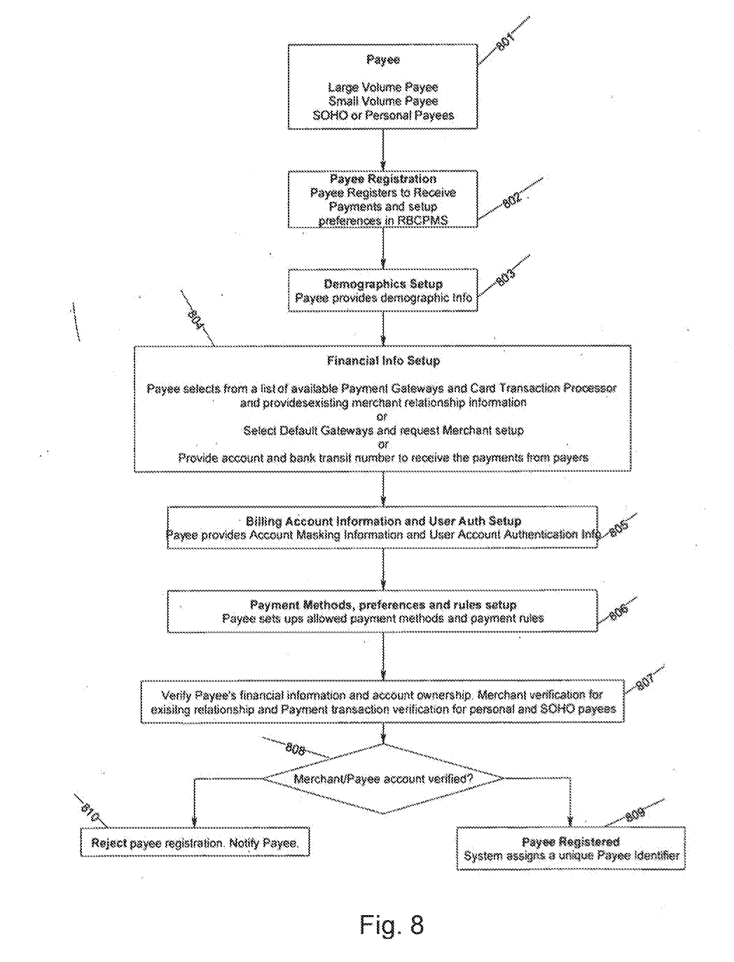

The payments are received by the core payment processing and routing engine (505). The routing engine first identifies the payee. In case of biller direct model of payment or source of payments, the payee is same for all the payments. However, for portal payments, the user sets up the payee associations from a list of registered payees or if the payee is not registered, the user can invite the payee to register with the system to receive the payments. The payee registration process is detailed in FIG. 8 of the present invention description.

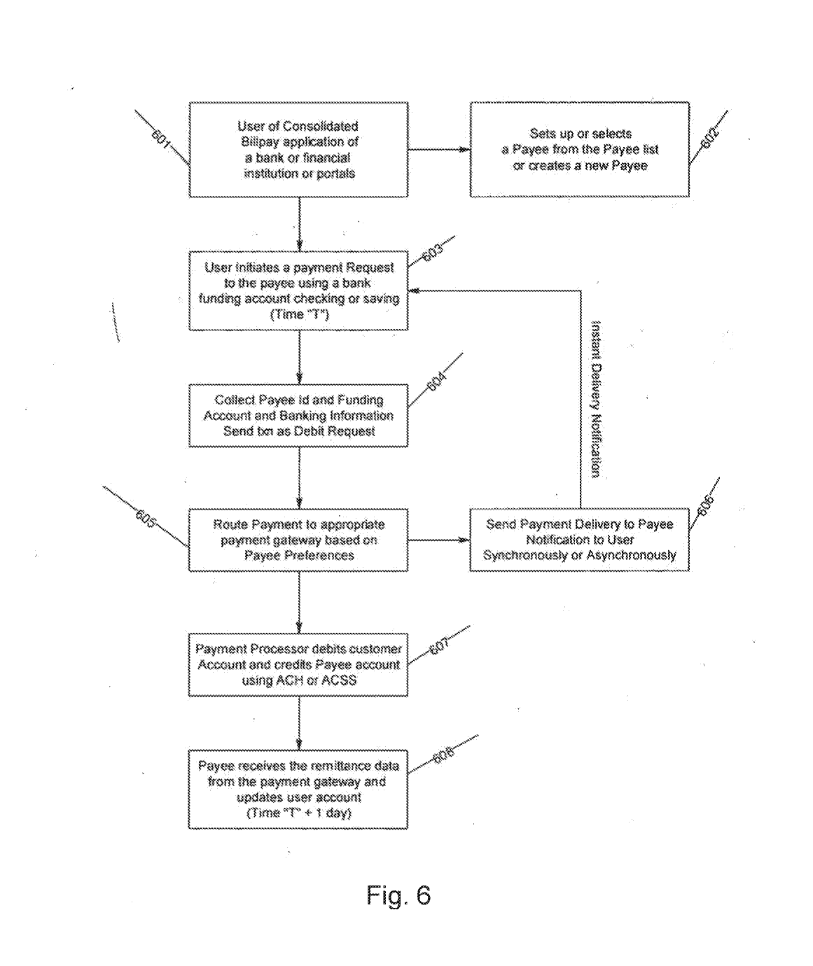

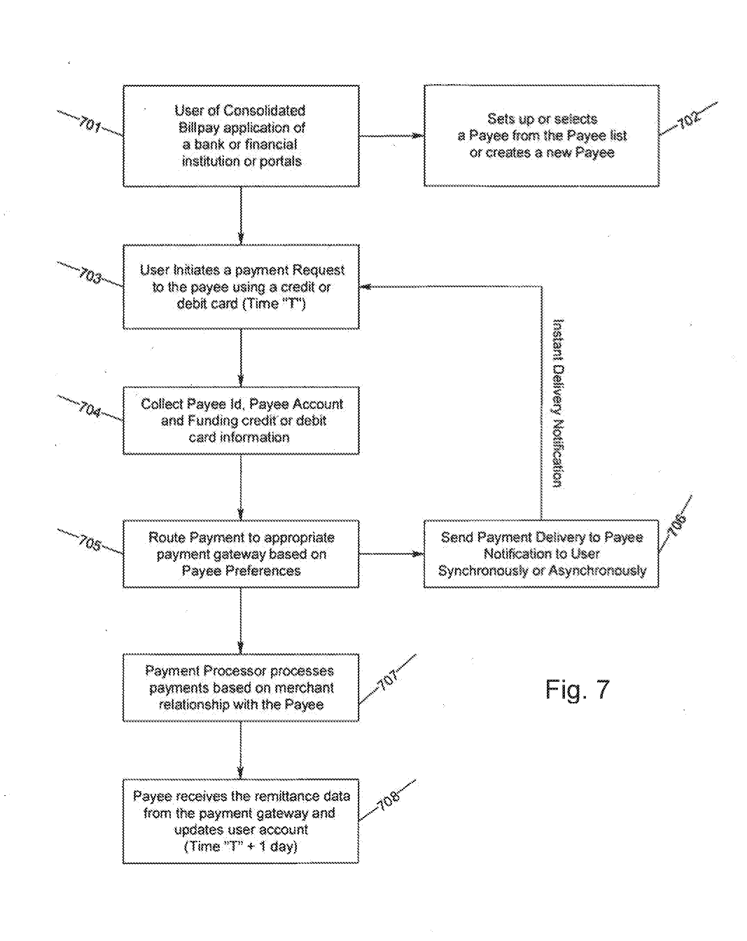

The payment transaction in the system is treated as a consumer draft or payment request or a payment draft. Once the routing engine 505 identifies the payee, it also identifies payment route based on the payee preferences defined by the payee. The payment route includes the payment processor for processing checking account funded payments and the card processor or merchant processor for processing card funded payments. A more detailed transaction flow for each type of funded transactions is detailed in FIG. 6 and FIG. 7 of the present invention description. The system also allows for default payment processors which the payee can select for either economic or convenience reasons.

Based on the type of payment funding instrument or the payee defined payment route, the payment is sent to the appropriate payment processor. This is done by payment routing engine 505 sending in batch(508) or online(509) format the payment transaction with routing information to the payment fulfillment sub system 510.

The payment fulfillment system 510 sends the payment transactions in batch or online to the payment processors. These payment processors have existing or prior merchant or lockbox/cash management relationship with the payment processors. As described in the background of the invention, most payees consider this channel of existing merchant and cash management relationship to be the preferred, if not the only payment processor and are very reluctant to use any other channels due to extensive changes on their end to integrate new payment processors.

One aspect of the present invention is to route the payment draft from the user (irrespective of the source of origination) to the payee's preferred channel of payment processing and substantially reducing and/or even eliminating the need for multiple settlements from multiple parties and substantially reducing and/or even eliminating the need for very extensive processes in the prior art.

Because the transaction from the user is considered as a payment draft from the user to the payee (irrespective of its origination, payee direct or portal payment), the funds are not needed to be debited from the user account prior to payment initiation, and the payment draft transaction is routed to the payment processor of the payee with whom payee already has or wants to have merchant and/or cash management relationship.

Once the payment fulfillment system 510, sends the payment to appropriate payment processor, the payment is processed as though the transaction was received from payee and the transaction is processed and settlement occurs between the payee and its merchant or cash management provider.

Because the payment transaction is treated as a payment draft and the payee information including the payee's processing preferences and allowed payment methods are stored as part of the payee's registration with the system and the payments are processed for the payee with its merchant and cash management processor, the system allows any type of payment method to be used by the user to pay the bill. As long as the payment method such as checking, credit card or debit card is allowed by the payee for processing payments, the system according to the present invention can allow that.

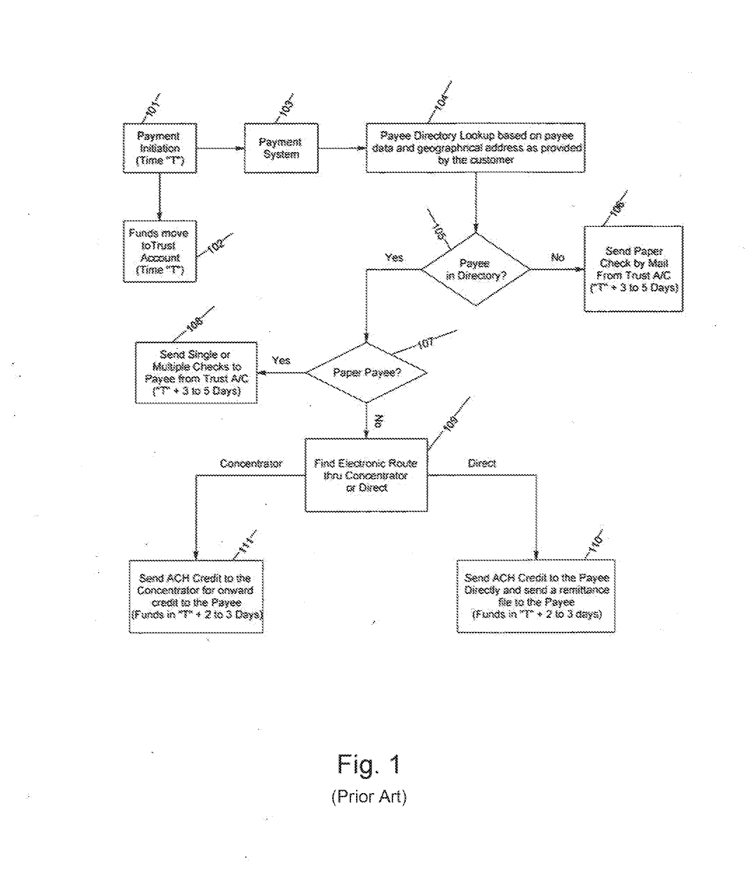

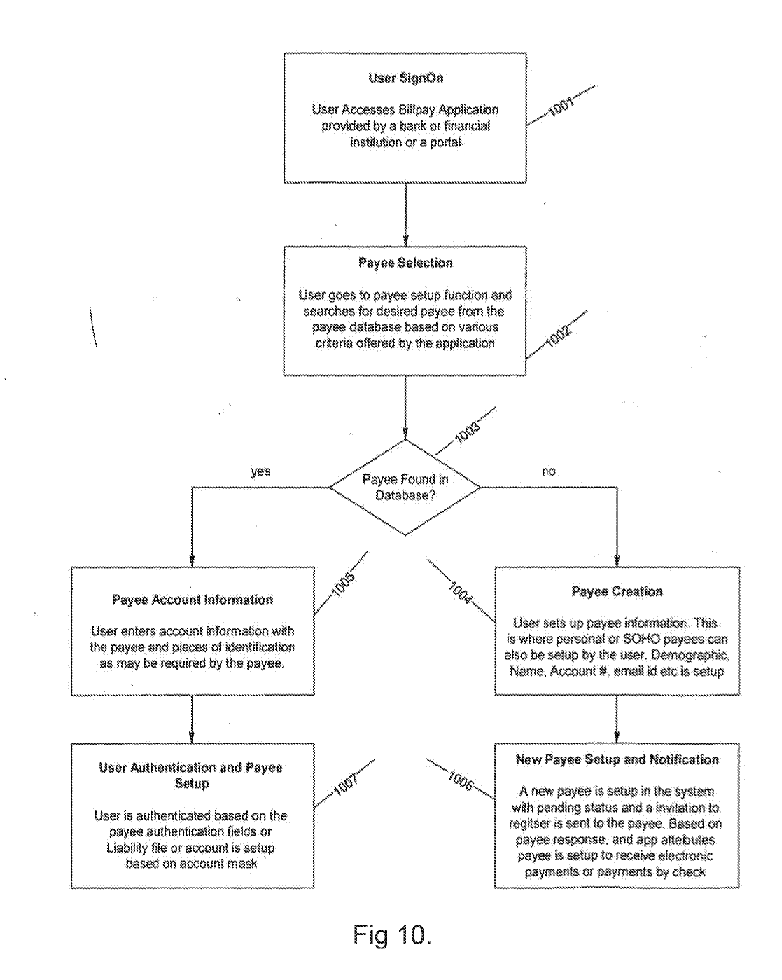

This means that the challenge for financial institutions to offer similar flexibility and speed as the payees on their own site, can be achieved. This can also reduce the cost of transaction processing as the payee is not unknown to the system and the payment is not being sent as paper as soon as payee is not identified. FIG. 10 discusses in detail how the payee is setup and how the challenges of the conventional payanyone bill pay system as discussed in FIG. 1 are substantially reduced and/or even eliminated.

Another step in offering flexible payment processing is to allow bill payments from un-enrolled customers of financial institutions. In case a user is not registered with the bank's internet banking and remembers to make a last minute payment, the user can go to his bank's site and make a payment to the payee by picking up the payee from the list and entering the payment method information in addition to authentication information as desired by the payee and potentially by the bank. This further enhances the financial institution's ability to offer similar functions as the payee as able to offer on their web sites or voice or wireless portals. This is possible, as discussed before, because of the different and unique treatment of the bill payment transaction as a payment request or payment draft to the payee and not an account transfer from customer's checking account to the payee.

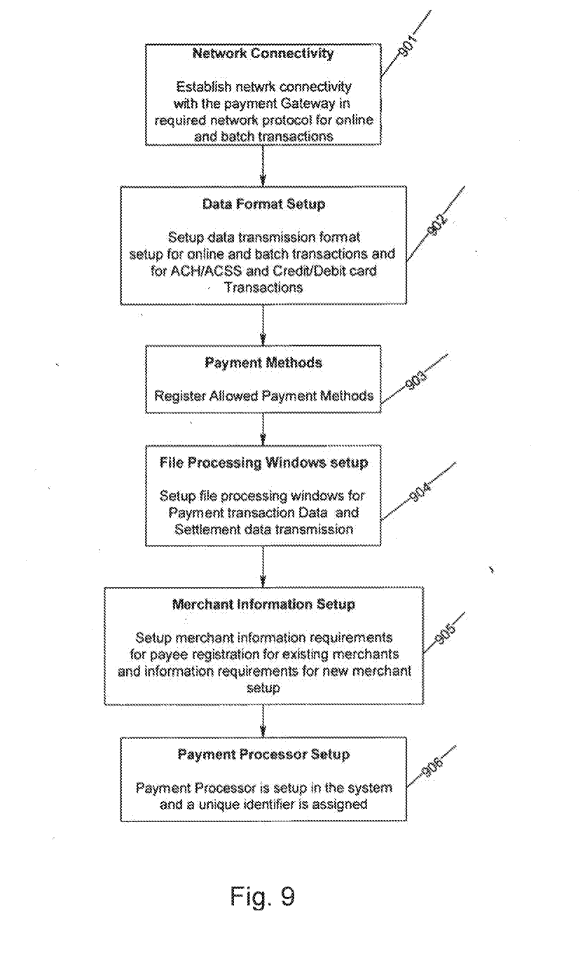

Embodiments herein also build a very successful and scalable model for payment processing whereby once the payment gateway is setup in the system and is attached to the payment fulfillment system 510, any payee who has any merchant, cash management, lock box or payment processing relationship with that payment processor or gateway can leverage the same. Details of how the payment processors and gateways are integrated with the payment network based on the current invention will be discussed in FIG. 9.

The system also allows for a default payment processor 512 who will typically be used by the SOHO payees or for person to person payments. The system also allows for a 3^{rd} party payment fulfillment 514 option via concentrators or checks in case portals or the payee prefer to receive payment using that channel.

The payment fulfillment system 510 sends the payment through a processing channel 512, 514, 516, 518 to payment processors for fulfillment.

Once the payment processor receives the payment, the payments are processed and funds moved from the consumer's account to the payee's account within the same day.

The system 519, 520, 521 provides a rules based consolidated payment management system which allows payees to setup various rules for payment processing and posting. The payees of all sizes:
large corporations such as AT&T, BellSouth;
medium size enterprises;
small businesses,
small office/home office;
individual payees,
   can all register or enroll to signup for the payment management system typically offered by their business bank or cash management bank or any other entity. Once the payee signs up for the payment management system, it allows the payee to setup rules for:
payment processing
   selection of payment processor based on method of funding;
   selection of payment processor based on type of account or product;
   other rules;
payment posting;
payment cut off times;
payment notification to the user
posting of processed payments based on rules defined by the payee:
   post payments for product P and/or account type A and/or payment funding method type P or to in format F to Receivable system R at time T using communication protocol C;
   Similar rules as deemed appropriate by the payee to streamline their remittance processing and posting system;
Customer notification messages and text;
Type alerts allowed by the system;
Fees to be charged for the transaction (convenience fee);
Payer-Payee account verification:
   Whether a payer-payee account verification required;
   If yes, define criteria:
      Online verification of account number or not;
      Account masks setup
      Authentication attributes to be setup;
      Authentication using liability file or by the payee;
Product type or account type needed for payment;
What information is needed for un-enrolled payments (one time payment);
Account mask setup;
Payment funding methods supported by the payee:
   Bank accounts;
   Credit/debit cards;
   Wire and any other payment methods;
Payees merchant processing relationships;
Payees financial information setup;
And other rules as entered by the payee.

The payment management system also can be used to receive payments from other conventional systems for payee to track all payments received thru the system.

The enrolment process for payee is also discussed in FIG. 8. Each payee is assigned a Unique Payee Identifier and the payee demographics, payee's financial information, payment preferences and rules are stored in the payee and rules database.

At the time of payment processing the routing system 505 will use the payee preferences to route the payment transaction.

In addition the payee can use the payment management system to query the system, search and sort the payments based on different criteria established by the payee.

FIG. 6 is a flowchart detailing payment processing flow for an account funded payment. The user 601 of portal payments (payanyone payment application of bank or a non-bank) sets up the payee relationship 602 by selecting a payee from the payee pick list or by creating a new payee record.

In step 603 The user initiates the payment transaction with funding account being a checking account with a bank. The system collects relevant payee, and funding account information in step 604. The payment is then routed to the payee's payment processor 605 and a payment delivery notification 606 is sent to the user. The payment processor receives a payment file with appropriate information related to the payments. The payment processor using ACH (USA) or ACSS (Canada) (or the like) debits consumer account and credits payee account.

In step 608, the payee receives the remittance file from the payment processor or the cash management bank of the payee. Because the payment transactions were originated in the same mode as payee's other payments, the remittance information received by the payee is posted same day.

This highlights:
a) payment is processed using the same channel as payee's majority of the payments;
b) remittance information is received by the payee in the same manner as the other payments (leveraging the cash management bank relationship, payee's preferred method of receiving payments);
c) payment is treated as a payment request and no funds are required to be pre-debited from the user account for payment processing;
d) the user typically receives a payment confirmation instantly as the payee is registered with the system and system sends a notification to the user immediately upon the payment scheduled for the cash management bank or the payment processor of the payee (instant confirmation from payee of payment request receipt significantly enhances the user's payment experience);
e) The payment is typically processed in the same day, the payee receives funds on the same day; and
f) The system has predictable payment response and a instant message delivery confirmation # from the biller which can also be verified by the biller using the agent dashboard, simply means that the confusion, from payment processing and the timing of debiting funds from consumer accounts and the funds availability to the payee, is reduced. This can result in improved customer experience, simplified payment processing and low cost of processing the payment.

FIG. 7 is a flowchart of payment processing when the funding account is a credit or debit card and not the checking account of a bank.

The user 701 of a portal payment system offered by the bank or non-bank sets up payees 702 to make payments to. In step 703, the user initiates a payment for a payee using a card. The system collects the payee id, funding account information such as card#, expiry date, name and address verification code etc. in step 704.

The system identifies the payee and the merchant processor relationship as registered by the payee. The payment is routed synchronously (in real time) or in batch to the payment processor in 705. A Payment delivery notification 706 is sent from the system to the user to confirm that payee has received the payment request (payment processing request). In this is aspect of the system, the payment confirmation to the customer is sent by the system on behalf of the payee (at payee's option). Because the confirmation number is based on the payee, all parties involved with the transaction are aware of the same confirmation # and can track and trace the payment transaction end to end by referring to the same transaction ID. (This is a big operational challenge in conventional payanyone bill applications (prior art) because the confirmation # issued by the banks has absolutely nothing to do with the confirmation # of the payee. When a customer, after making the payment on his bank's site, calls the payee and refers to the confirmation #, payee has no way of cross checking or tracking that payment. Many times, the service providers based on prior art technologies have to call payees to verify if the payment was received. This is yet another fundamental issue driving cost of payment processing high. For early, adopters banks could charge for the service, however, at this stage of the marketplace, sometimes banks have to pay for the user to use bill payment service. Operational efficiencies and cost of operating a payment processing operation has become a very big factor. The present invention's ability to allow all parties to refer to the same payment transaction and track and trace it like a shipment (all parties can track with same shipment #) would bring tremendous benefit to the customer, and for payee and the financial institutions by reducing operation cost of tracking and tracing payment items.

The payment processor processes the payment in realtime or batch and sends the confirmation # back to the payment fulfillment system. The payee receives the payment through merchant settlement same day.

The payment processing has been simplified. The payee is able to register with the payment network, and update the system with its payment preferences including the payment methods which are acceptable to the biller.

Benefits:
a) An enhanced user experience for the user of a bank's or any other portal's payanyone bill pay offering;
b) Banks, financial institutions, and portals can offer functionality allowing user to choose variety of payment methods as allowed by the payee; and
c) Payees received payments from financial institution's user much quickly for improved cash flows.

FIG. 8 describes a flowchart of the process for payee's registration with the bill payment system according an embodiment of the present invention. Payees can self register for the application. The payee can register for receiving biller direct payments and also can register to receive payments from payanyone bill pay application. The self registration subsystem can be accessed at multiple places, such as:
a) Directly at the bill payment service provider according to the present invention for biller direct and/or payanyone bill pay application;
b) Bank's business banking or cash management web banking portal;
c) Part of Bank's billpay application portal;
d) Any other application or billpay portal or business portal where companies small or large or personal payees frequent.

Any payee 801 can register with the system, such as:
a) High volume billers like many marquee national names;
b) Smaller companies with regional presence;
c) Small office home office (SOHO) type entities; and
d) Personal or any other type of payee.

A payee who intends to receive the payment electronically through prior art payanyone applications can register with the payment system. The payee accesses the payee registration subsystem and registers to receive the payment 802.

In step 803, the payee enters its name, address and other demographic information. Step 804, payee sets up financial information for payment processing. The payee can have multiple options to choose from:
a) If a payee has an existing relationship with a payment processor or merchant processor and cash management relationship with a bank, it can select those as payment processor(s) of choice. In this scenario, the payee provides the information needed for the payment processors to authenticate, and identify the payee and later use it for payment processing.
b) Other option for the payee is select the default payment processor for processing payments. In this case, the payee will need to establish merchant relationship with the payment processor.
c) Another option which is more relevant for the SOHO or personal payees, is to allow these payees to receive payments or account transfers into their accounts. The payees need to provide required account number, the bank transit numbers for proper routing of the transactions into their accounts.

Next, step 805 is where payee provides billing account related information and the user authentication information which will later be used by the verification and authentication of the users. The bill pay system according to present invention allows payees to not only setup the account masking information which is used to verify account formats, the payees can also opt to mandate the user to provide certain authentication information to verify account ownership by the user. Example of this information can be Social Security Number and Account Number or any other information attribute which the payee can authenticate the user with. Typically, this information is present in the liability file provided by the user.

Next, step 806 has the payee set up different payment methods and associate different products, account masks to different payment processors. These options can be as follows:
a) Allow the payment processing for checking account funded transactions for the product A, with Mask M1 to processed by payment processor P1;
b) Similarly, the payee can choose for card funded transactions based on the account mask or the funding method such as Visa, Mastercard, Amex, debit/credit and so forth.

This flexibility in payment processing allows freedom to the payees for payment processing. The payment system can reduce fraud possibilities, as proper authentication of the billing account is performed before a user can setup a billing account.

Step 806 also allows payee to setup different payment processing and posting rules as described in FIG. 5 steps 519, 520 and 521.

In the next step 807, the payee's financial and merchant processing information is verified by the system by communicating the billing information with the merchant processors or cash management bank. In fact, system allows for self enablement of payees function to be performed by:
a) banks and financial institutions on their corporate and business banking sites;
b) cash management banks on their web portals;
c) web portals on their business web sites; and
d) any other web site offering business functions to their customers.

This is done to allow integration of payment setup as part of the larger business offering. This can also streamline authentication process.

Once the merchant relationship with the payment processor has been verified the payee is setup on the system and a unique payee identifier (“UPN”) is assigned by the system to uniquely identify the payee for all payment processing needs.

However, if the information cannot be verified, the payee request for enrollment is denied and payee is notified as such.

For the personal payees, the account ownership is verified by making couple of random payment transactions to the funding account and the payee is asked to enter that information to sign up.

Once the payee is verified, the system registers the payee and a unique payee identifier is assigned. If the payee is not verified, the request to enroll is denied and the payee is notified.

FIG. 9 is a flowchart detailing the process of setting up new payment processors on the bill payment system according the present invention.

The first step 901 is to setup the network connectivity with the payment processor in the desired network connection type and protocol. Examples can be X25, TCP/IP, dial connection etc.

Next step 902 is to establish a data format setup for online and batch transactions. The file formats are agreed and the bill payment system is setup to process these files and exchange payment data in these formats. In step 903, bill payment system also defines payment methods accepted by the payment processor and these methods are defined in the system. When the payee is picking up payment processor preferences, the payment methods allowed by the payment processor are also indicated as pick list to the payee to choose from.

In the next step 904, the payment processor file exchange windows are setup based on the cut off times of the payment processor. This is also used to maximize the benefit of posting the payments with least amount of time between origination and settlement.

Next step 905 bill payment sets up the merchant information setup requirements by the payment processor. This information is used by the bill payment system according to the present invention for payee setup. A payee is asked to provide all the necessary information required by the specific payment processor to setup with the system.

The last step 906 is to setup the payment processor in the bill payment system ready to accept payments from the merchants.

FIG. 10 is flow chart describing the payee link setup by the user of the bill payment application according to the current invention.

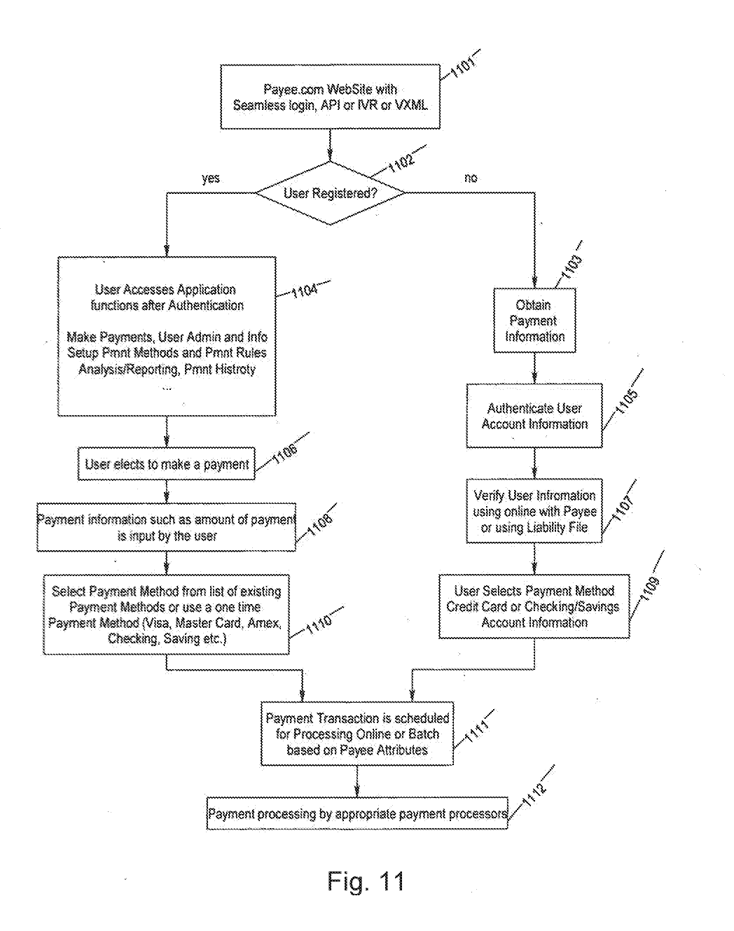

The user accesses the application in step 1001 and goes to the payee setup function of the user interaction. The user interaction is detailed in the FIGS. 11 and 12 of the present invention description. Next at step 1002, the user performs a payee database lookup to search for the payee. If the payee is found in the database per step 1003, the user provides the payee account information with authentication attributes as required by the payee (1005). The next step 1007 uses this information to verify and authenticate the user. If successful, the payee is setup. If the payee so chooses, the authentication information can be made optional and if the account information entered by the user follows the account mask, the payee could be setup without authentication. However, this results in much reduced fraud protection.

If the user does not find the payee in the database as per verification step 1003, the user can create a payee. This step is particularly helpful in establishing SOHO and personal payees. The user is asked to provide name, address, account# and other demographic information about the payee including the email address (step 1004).

At step 1006, if the email address is not known, the payment will be typically sent as a paper check drawn on user's checking account. If the email address is known, an email is sent to the payee as an invitation to enroll. If the payee responds by accessing the secure link, the payee is provided with the payee setup functions to register. If the payee does not respond within certain timeframe as setup by the application provider, the payee is setup as a check payee and the payments are sent as check payments.

FIG. 11 is a flow chart of user interaction with the payee direct user dashboard, according to the present invention. The interaction focuses on payment initiation part of the process flow and mentions some of the other main features of the system.

The interaction starts with step 1101 whereby the user accesses the system through web, voice or wireless portal of the payee. The interaction with the bill payment system can be through dashboards, seamless login or an API.

User registration is verified as the next step 1102. If the user is not registered, the system treats that user to be accessing the system for the purpose of making an un-enrolled payment. The user is asked to enter the payment amount information in step 1103 and user is also asked some key authentication questions in step 1105 based on the system definition by the payee.

Step 1107 authenticates the user and verifies user's account ownership using the liability file or other verification process as selected by the payee including online request/response model to authenticate the user. Once the user is authenticated, the next step 1109 is select a payment method based on the payment methods allowed by the payee. These can be, for example, Checking account, Credit, Debit cards and the like.

Next step 1111 schedules the payment for processing, and in certain embodiments, such processing is immediate. The payment is processed (1112) based on the payment processor preferences by the payee. The credit card payments are typically processed in real time while ACH/ACSS type of payments are sent in batch mode. The settlement typically occurs within the same day.

However, if the user is a registered user with the system as verified by step 1102, the user can access multiple functions offered by the system. Some of the key functions are:
a) User admin
b) Setup payment methods
c) Schedule payments, setup recurring payment rules
d) Analysis/Reporting
e) Tracking/tracing of payments
f) Payment adjustments, payment cancellation
g) View payment history
h) Make payments

For the purpose of the discussion, the user elects to make a payment step 1106. User provides payment information 1108, and selects a payment method for funding the payment transaction 1110. The user can select a payment method either from a list of previously setup payment methods or can use a one time use payment method. As discussed above, the payment is then processed per steps 1111 and 1112.

FIG. 12, is a flowchart of the user interaction with the payanyone bill payment system according to the present invention. This interaction can occur either at any type of interface, such as web, voice or wireless portal of a bank or a non-bank payanyone bill payment application provider. The bill payment system can be accessed via directly connecting to the user dashboard, API or via seamless login.

The user can perform multiple functions at the system. Some of the key functions are:
a) User Admin
b) Setup payees
c) Make payments
d) Schedule payments, setup recurring payment rules
e) Setup payment methods
f) Cancel or adjust payments
g) Analysis/Reporting and view payment history

In step 1203, the user decides to make payment. The user selects payee or payees from the list of payees the user has previously setup (1204) and provides payment amount information (1205) and selects a payment method or payment methods (1206) depending on how many payees the user is paying and what methods user chooses for each payee out of the payment methods allowed by these payees. The payment transaction(s) are now ready for processing (1207) and payments are routed to the appropriate payment processor for processing (1208) and the user receives payment delivery confirmation with a confirmation number to confirm payment processing. The user can track/trace payment status using the same application interface.

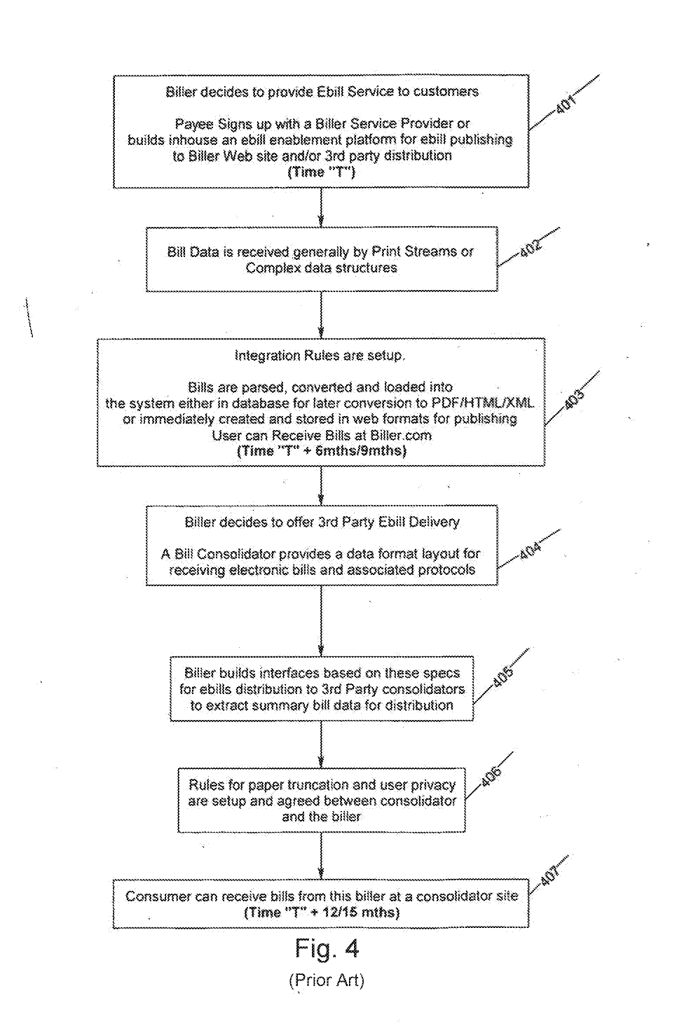

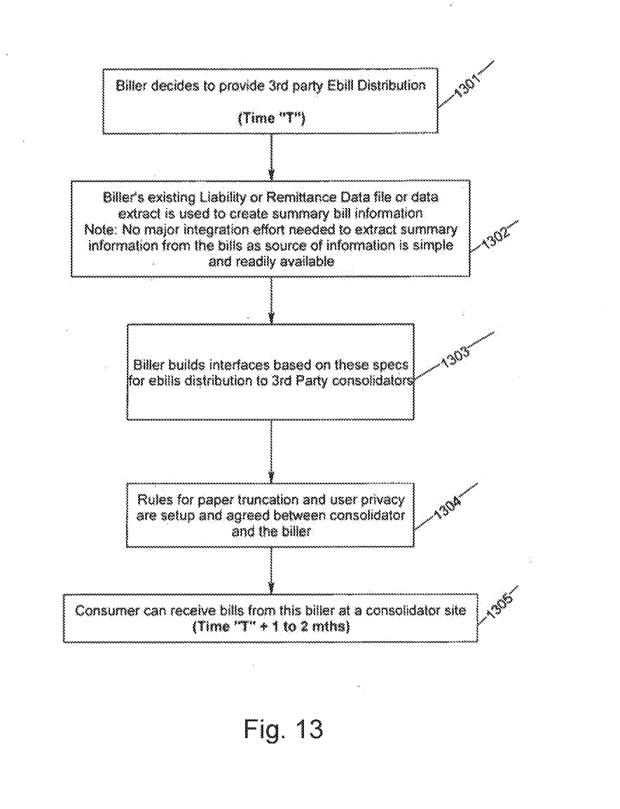

FIG. 13 is a flow chart of a 3^{rd} party summary bill information delivery by the payee to the consolidators according to the present invention. As described in FIG. 4, the ebill distribution is a very complex, costly and time consuming process based on the conventional delivery models.

As per the present invention, the bill payment system substantially reduces and/or eliminates the dependency on the conversion of payees bills to electronic format for extracting summary bill information. Instead it uses a the remittance information contained in remittance file or liability file as the source of providing summary bill information. Irrespective of the size of the payee, big or small in terms of payment volume, have an accounting system with account receivable information. Each time a payment is made, the system updates the account with the remittance information for updating receivable information. The present invention uses the existing data for creating and transmission of ebill information to 3^{rd} party consolidators.

Each payee has a Account Receivable or Liability file or some data set which identifies the consumer's owing to the payee. Embodiments of the present invention use the liability file or some version of that to extract the remittance information and use is to provide summary bill information to the bank or any other consolidators.

Because this information is readily available with the billers and the bill payment system, recognizing that summary information is nothing more than the information on the remittance stub as part of the bill to the consumer or the account receivable or liability file.

This simplifies the creation and delivery of the summary information. Secondly, it resolves the chicken and egg problem currently faced by the bill pay industry to enable 3^{rd} party ebill distribution.

What is claimed is:

1. A system for a payer to make payment to at least one of a plurality of payees
comprising:
at least one computing device configured to receive bill payment instructions originating either from said payer or a selected one of said payees, said instructions including:
an identification of said selected one of said payees;
an identification of an account belonging to said payer and selected from the group of funding accounts consisting of checking accounts, savings accounts, credit card accounts, and debit card account; and
an amount to be debited from said funding account and to be remitted to said payee, and
said at least one computing device being further configured to:
present a first notification, synchronously in real-time to said payee, that a payment transaction has been routed to said payee; and
present a second notification, synchronously in real time or asynchronously, to said payer, on behalf of said payee, that said payment transaction has been routed to said selected one of said payees,
wherein said first notification and said second notification comprise a bank confirmation number based on said payee.

2. The system of claim 1 wherein said payer is an individual consumer or a business.

3. A system of claim 1 wherein payer's funding accounts are associated with one or more financial institutions.

4. A system of claim 3 wherein said account selected by said payer is from a list of funding methods that are predefined as acceptable by said payee.

5. A system of claim 4 wherein said payment instruction includes an identification of a receivable account associated with a relationship between said payer and said payee, to which said payment amount will be applied against a liability of said payer.

6-32. (canceled)
